(19) United States
(12) Patent Application Publication
(10) Pub. No.: US 2013/0185106 A1
(43) Pub. Date: Jul. 18, 2013

(54) USING SOCIAL MEDIA OBJECTS FOR CONTENT CURATION, MANAGEMENT, AND ENGAGEMENT FACILITATION

(71) Applicants: Frank J. Donatone, Eastchester, NY (US); Maria K. Ruotolo, Huntington Station, NY (US); Rajendran Subramaniam, Tucson, AZ (US); Tiffany L. Winman, Phoenix, AZ (US)

(72) Inventors: Frank J. Donatone, Eastchester, NY (US); Maria K. Ruotolo, Huntington Station, NY (US); Rajendran Subramaniam, Tucson, AZ (US); Tiffany L. Winman, Phoenix, AZ (US)

(73) Assignee: INTERNATIONAL BUSINESS MACHINES CORPORATION, Armonk, NY (US)

(21) Appl. No.: 13/352,204

(22) Filed: Jan. 17, 2012

(51) Int. Cl. G06F 17/30; G06Q 10/06

(52) U.S. Cl. 705/7.14; 707/776; 707/E17.116; 707/E17.014; 707/E17.044

(57) ABSTRACT

Provided are techniques for updating web content. A data mining scan of one or more data sources is performed for one or more topics to identify one or more trending topics. One or more relationships of the one or more trending topics to content objects are identified. One or more recommendations on how to update the web content based on the one or more relationships are provided. Input is received on the one or more recommendations. In response to the received input, the web content is automatically updated based on making associations between the web content and the content objects.

### FIELD

Embodiments of the invention relate to using social media objects for content curation, management, and engagement facilitation.

### BACKGROUND

Social media may be described as using web-based and mobile technologies for interactive discussions. Today, some tools can capture social media discussions.

Some social media tools identify “trending topics.” Trending topics may be described as topics that are popular (e.g., on the internet). Also, some social media mining tools have customer relationship management workflow capabilities.

Nonetheless, use of the social media discussions and trending topics may be improved.

### SUMMARY

Provided are a method, computer program product, and system for updating web content. A data mining scan of one or more data sources is performed for one or more topics to identify one or more trending topics. One or more relationships of the one or more trending topics to content objects are identified. One or more recommendations on how to update the web content based on the one or more relationships are provided. Input is received on the one or more recommendations. In response to the received input, the web content is automatically updated based on making associations between the web content and the content objects.

### BRIEF DESCRIPTION OF THE SEVERAL VIEWS OF THE DRAWINGS

Referring now to the drawings in which like reference numbers represent corresponding parts throughout:

FIG. 1 illustrates a cloud computing node in accordance with certain embodiments.

FIG. 2 illustrates a cloud computing environment in accordance with certain embodiments.

FIG. 3 illustrates abstraction model layers in accordance with certain embodiments.

FIG. 4 illustrates a computing environment in accordance with certain embodiments.

FIG. 5 illustrates, in a flow diagram, operations performed by a Social Media Content Curation and Workplace (SMCCW) system in accordance with certain embodiments. FIG. 5 is formed by FIG. 5A and FIG. 5B.

FIG. 6 illustrates, in a flow diagram, certain operations performed by an input agent in accordance with certain embodiments.

FIGS. 7A, 7B, and 7C illustrate an example of updating a web page with content objects managed by a content management system in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

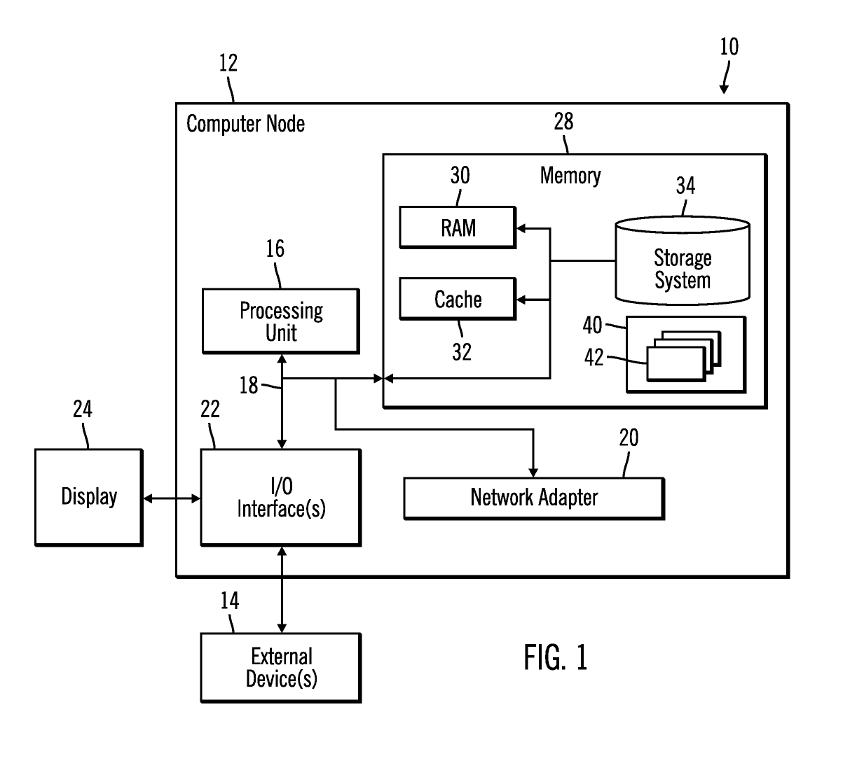

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

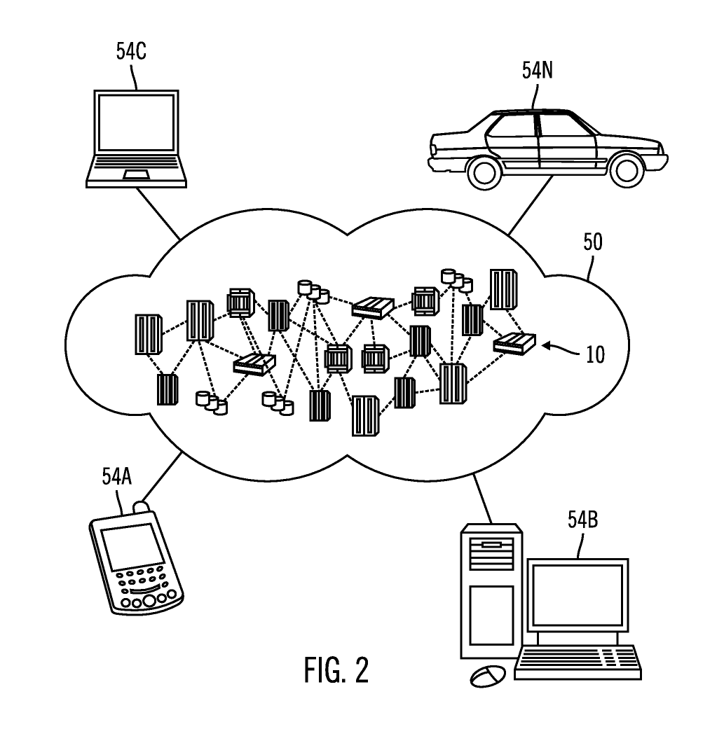

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

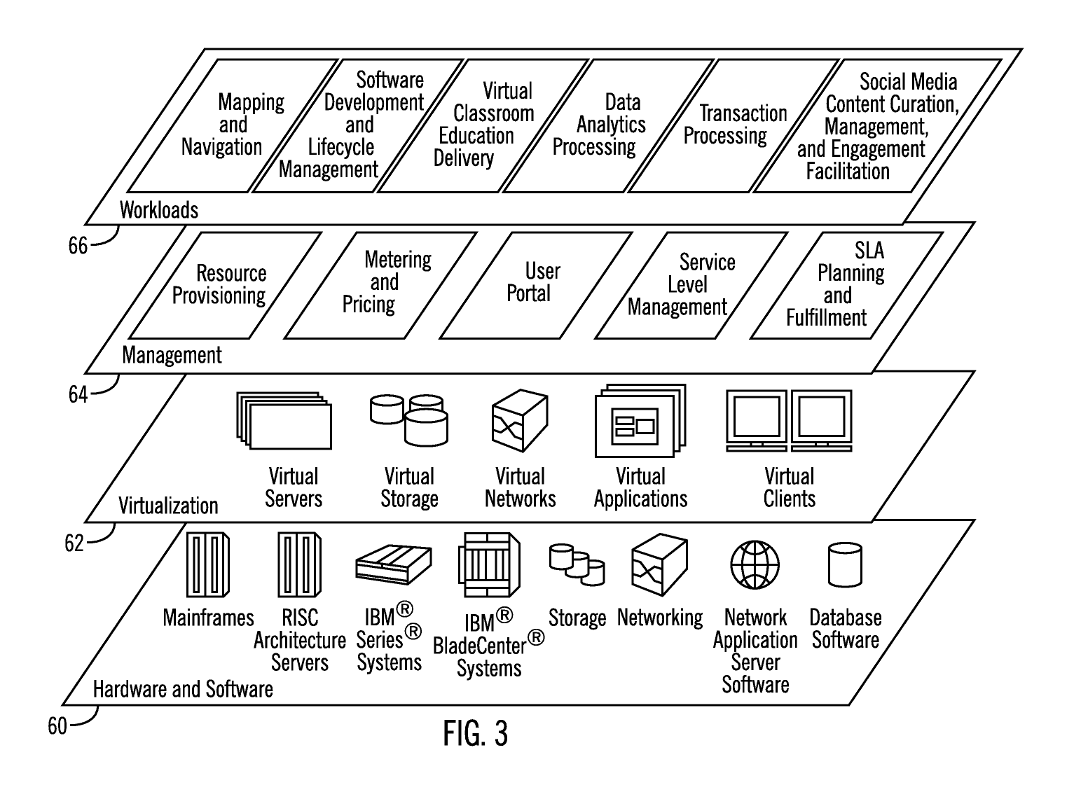

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and social media content curation, management, and engagement facilitation.

Thus, in certain embodiments, software, implements the social media content curation, management, and engagement facilitation, in accordance with embodiments described herein, is provided as a service in a cloud environment.

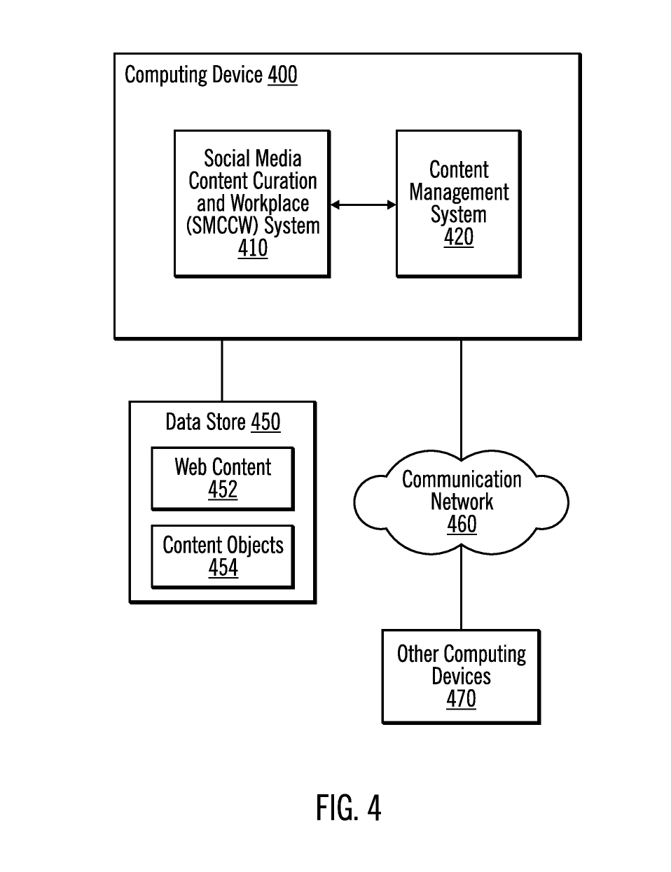

FIG. 4 illustrates a computing environment in accordance with certain embodiments. In FIG. 4 a computing device 400 is coupled to a data store 450 and is coupled, via a communication network 460, to other computing devices 470. In certain embodiments, the computing devices 400, 470 may include the components of the computing device illustrated in FIG. 1.

The computing device 400 also includes a Social Media Content Curation and Workplace (SMCCW) system 410 and a content management system 420. The content management system 420 manages web content 452 (i.e., data) and content objects 454 stored in the data store 450.

The SMCCW system 410 mines social media (media for social interaction) for trending topics and also mines the content management system 420 for related content objects 454. The SMCCW system 410 matches trending topics to existing content objects 454 and makes recommendations for changes to digital content on a web page. The SMCCW system 410 allows administrators to receive these recommendations, vet the recommendations, publish the recommendations, and then measure the effectiveness of the content (e.g., audience appeal as measured by clickthrough traffic). The SMCCW system 410 also provides a workflow for content approval, automation capabilities, metrics reporting, and predictive intelligence for learning and automating changes to a web page's data content and meta content. A workflow may be described as a process for performing a series of connected operations. Predictive intelligence may be described as the ability to quickly analyze data, examine variables, and uncover relationships and possible outcomes. Over time, the SMCCW system 410, which is based on predictive intelligence, learns and, therefore, improves relevance of input and output.

Social intelligence may be described as the ability to analyze social data (i.e., shared content objects including posts, tags, images and videos) and examine the social data and uncover relationships and possible outcomes (such as trending topics).

The SMCCW system 410 provides timely relevant information and leverages social intelligence to keep web content fresh and interesting by: knowing hot themes of digital conversation related to topics of importance to a business, automatically surfacing these social conversations on a website, identifying which of web content maps to these timely social themes, and then enabling and automating updates of web content that is related to the website in a way that maintains the brand reputation of the business.

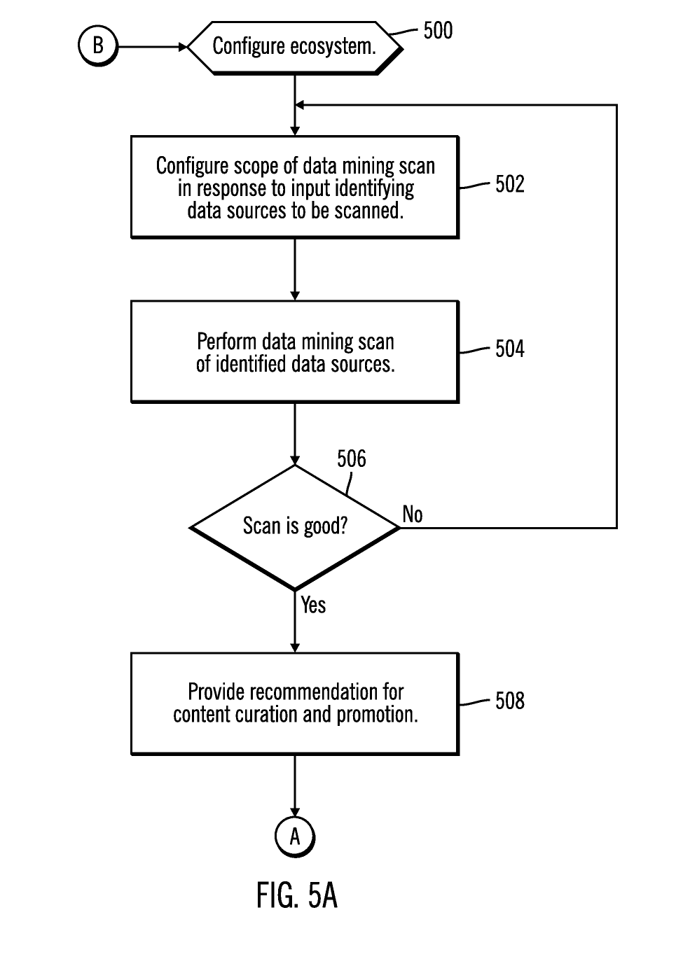

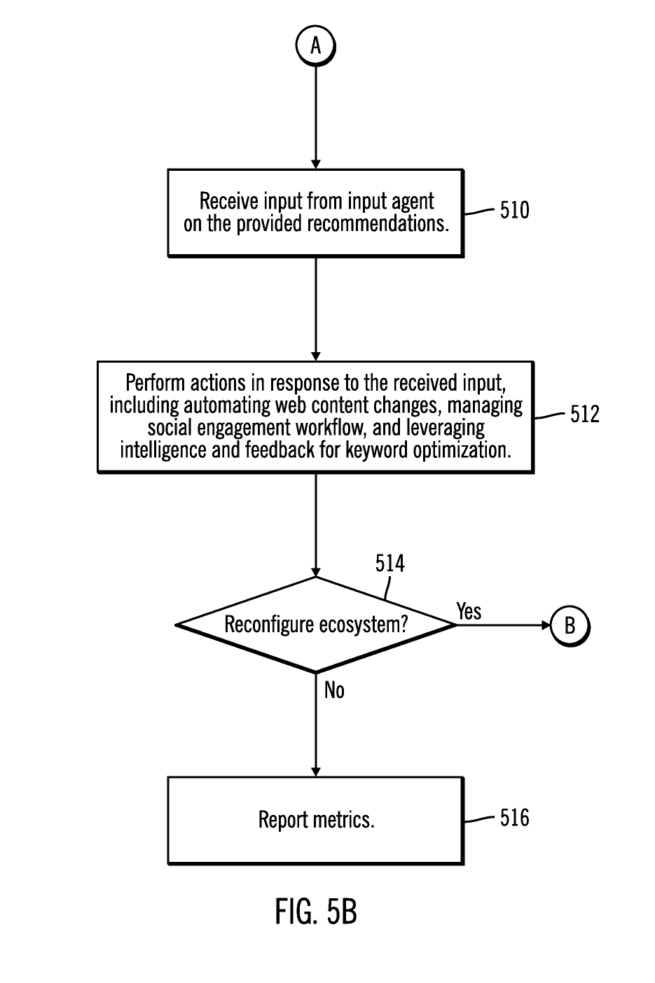

FIG. 5 illustrates, in a flow diagram, operations performed by the SMCCW system 410 in accordance with certain embodiments. FIG. 5 is formed by FIG. 5A and FIG. 5B. Control begins at block 500 with the SMCCW system 410 configuring the ecosystem in response to input. The input may be from one or more input agents. The input agents include, but are not limited to, any human user (e.g., input agent), application, device or other system.

In particular, the input agent provides input to configure the ecosystem by defining the ecosystem and business rules. This involves setting up the ecosystem by identifying the relationship between the types of data sources of social media and types of content. This includes a categorization to show the relationship between the data source and type (e.g., xyz=micro blog, abc=Q&A site). Also, missing and new data sources may be added.

To map the ecosystem, the input agent provides input to identify relationships between topics and keywords for search and data mining. Keywords may be described as word phrases that are used to search databases (indexes) including online library catalogues, World Wide Web (WWW) search engines, content management systems, and social media. That is, keywords are used in queries to search for content objects. The input agent provides input to configure the ecosystem to use identified topics and match them to keywords. The input agent provides input to categorize keywords to align with their associated topics and offerings (e.g., “hardware”=servers and storage). The input agent provides input to categorize hot words to align with their associated actions (e.g., pricing=sales).

To map the content management system 420, the input agent provides input to identify relationships between topics and keywords for search and data mining. The input agent provides input to configure and connect to the target website's content management system. The target website may be described as the website for which the SMCCW system 410 will provide recommendations. The input agent provides intelligence on relationships between external social content objects and the content in the content management system 420.

The input agent provides input of feedback and metrics for ongoing intelligence around keywords, hot words, topics, and quality of the associations.

Also, the input agent provides input to create profiles. The input agent may set up profiles and map the profiles by role, geography/language, and topic/brand. The profile may be configured to work with an existing profiling system (i.e., of a business, such as a company or enterprise) to recommend certain people by role, geography/language, and topic/brand. Based on the selection and inclusion of a person in a profile, the SMCCW system 410 builds a person's social media connection network. For example, if a person's profile contains a social media account, the SMCCW system 410 looks at the person's followers and creates a map of the person's extended network.

The input agent may also configure a Uniform Resource Locator (URL) shortener for consistency and metrics gathering. URL shortening may be described as a technique in which a URL is shortened in length and still directs to the correct web page.

In block 502, the SMCCW system 410 configures the scope of a data mining scan in response to input identifying resources to be scanned. In certain embodiments, the data sources may be described as social media, such as, but not restricted to, content sharing repositories (e.g., videos, images, podcasts, white papers, etc.), web-based communities, micro blogs, blogs, web-based discussion forums, and other social media websites.

For example, the input agent identifies a list of available data sources to scan, including the resources that are owned by a website owner (e.g., of a business). The input agent may add new or missing data sources. The input agent may identify preferred data source types (e.g., news, blogs, discussion forums, social networking websites, etc.). The input agent may remove unwanted data sources (e.g., by excluding data source names). The input agent identifies the topics to scan for, and these topics may automatically be associated with a predefined set of keywords to scan with identified hot words to refine. The input agent may make adjustments to the predefined set by adding or excluding keywords or hot words. The input agent identifies the frequency of the scans.

In block 504, the SMCCW system 410 performs a data mining scan of the identified data sources. The SMCCW system 410 scans the data sources defined during configuration. The SMCCW system 410 produces results, including feeds, email alerts and/or search results based on the configuration settings specified. The scan on search results extends the data mining beyond social media.

In block 506, the SMCCW system 410 determines whether the scan was good. If this scan was good, the SMCCW system 410 continues to block 508, otherwise, the SMCCW system 410 loops back to block 502 to re-configure the scope of the data mining scan. In certain embodiments, the SMCCW system 410 determines whether the scan was good by looking at the relevance of the results. For example, if the results are irrelevant, the input agent is likely to modify the rules of the scan (e.g., by changing the keywords to be included or excluded, with keyword modifiers, changing data sources and time frames, etc.).

In block 508, the SMCCW system 410 provides recommendations for content curation and promotion. Content curation may be described as discovering, gathering, and presenting digital content that surrounds specific subject matter. For example, the SMCCW system 410 may inform the input agent of relevant content assets (e.g., images, snippets, videos, case studies, etc.) and matching targets (e.g., web pages, social presences, and other communication vehicles). In particular, the SMCCW system 410 publishes the results of the data mining scan (e.g., to an administrator view) on a regular schedule (e.g., hourly, daily, etc.). The SMCCW system 410 saves the trending topics and their related content objects to the data store 450. These content objects are inclusive of profiles, posts, tags, videos, images, podcasts, documents, etc. Social media objects may be described as “content objects in social media” or shared content objects. Social media objects include, for example, posts, images, videos, files, tags and profiles. The SMCCW system 410 provides a visual view of the data collection by displaying trending topics (e.g., in a tag cloud) and allowing an input agent to drill down into the topics. The SMCCW system 410 displays the associations around each topic, such as keyword, author, and data source. The associations around each topic may be displayed as a word cloud with a mind map or other graphical interface to show the relationships. The input agent is able to select a few words from the word cloud and see a mind map of the related social media objects (e.g., images, videos, and content) and object attributes (e.g., keyword, topic, source, author, and date).

In block 510, the SMCCW system 410 receives input from the input agent on the provided recommendations. The input agent may review and act upon the social media objects. The input agent may filter social media objects by object attributes (e.g., keyword, topic, source, author, and date) as desired. The input agent marks and categorizes the status of individual social media objects (e.g., hot or Not Applicable (“N/A”)).

In block 512, the SMCCW system 410 performs actions in response to the received input. The actions include automating web content changes, managing a social engagement workflow, and leveraging intelligent feedback for keyword optimization. To manage recommendations, if a social media object is marked as hot, the SMCCW system 410 places the social media object into a queue for one or more actions. In certain embodiments, the SMCCW system 410 performs the actions in order as follows: (1) automating web content changes, (2) managing a social engagement workflow, and (3) leveraging intelligent feedback for keyword optimization. To manage recommendations, if a social media object is marked as N/A, the SMCCW system 410 uses this data for leveraging intelligent feedback for keyword optimization.

As to automating web content changes, the SMCCW system 410:
makes associations between the social media objects and web content;
scans the content management system 420 to see if any digital media available on the content management system 420 matches the social media objects so that the social media objects can be promoted on appropriate web pages;
associates social media objects with web content based on commonalities (e.g., meta tags);
allows the input agent to select which digital assets to display (e.g., none, some or all); and
allows the input agent to schedule the display of specific pieces of content (e.g., say if the content matches, the input agent can set a “go live” and expire date for that content to be active on the web).

As to managing a social engagement workflow, the SMCCW system 410:
recommends which people inside the business (e.g., an expert) to notify to act upon the provided recommendations; and
provides a mind map of the expert's social network.

Then, the input agent may review the influence of the expert and the expert's social network. In certain embodiments, the influence is based upon the number of followers on a blog or other social media. The input agent may decide which people to engage to respond to each of the social media objects and assigns the social media objects to them for appropriate action. The input agent may track what action was taken on the social media object.

As to leveraging intelligent feedback for keyword optimization, the SMCCW system 410:
makes keyword recommendations based on all prior steps;
based on the actions of the input agent (e.g., the input agent associating hot or N/A with social media objects), creates a potential includes and excludes list for keywords and social media data sources that the input agent may reference and may update the configuration and allows the input agent to update the configuration;
depending upon the business rules, either automatically acts on these includes or excludes on the list or recommends them to the input agent (i.e., as a set of keywords or hot words to be added to the configuration of the ecosystem or the scope of the data mining scan), providing data sources or authors to be excluded from the configuration of the ecosystem, and/or providing data sources or authors to be prioritized; and
makes meta content changes to the web page for search engine optimization (i.e., so that the search engine would find that web page during a search).

In block 514, the SMCCW system 410 determines whether the ecosystem should be reconfigured based on the business rules. If so, processing continues to block 500 (FIG. 5A), otherwise, processing continues to block 508.

In block 516, the SMCCW system 410 reports metrics. The SMCCW system 410 reports on actions occurring in the SMCCW system 410. For example, the SMCCW system 410 provides data mining metrics, workflow metrics, effectiveness metrics, views and other data.

The data mining metrics may include a number of social media objects that came through the SMCCW system 410, a number of social media objects from various data sources (i.e., domains) and data source types (e.g., content sharing repositories, communities, micro blogs, blogs, forums, etc.); a number of social media objects from individuals (e.g., influencers).

The workflow metrics include a number of social media objects for which web content was added, a number of social media objects engaged, and a number of metrics on digital assets promoted. In particular, for the number of social media objects engaged, the SMCCW system 410 provides the number of social media objects to which the subject matter experts within the organization responded (e.g., by replying to a tweet or a forum).

The effectiveness metrics include: best/worst performing keywords, topics, and content assets.

The views include: summaries, totals, trends, and graphical examples.

The SMCCW system 410 allows drill down into details and relationships to other content/social media objects in the metrics.

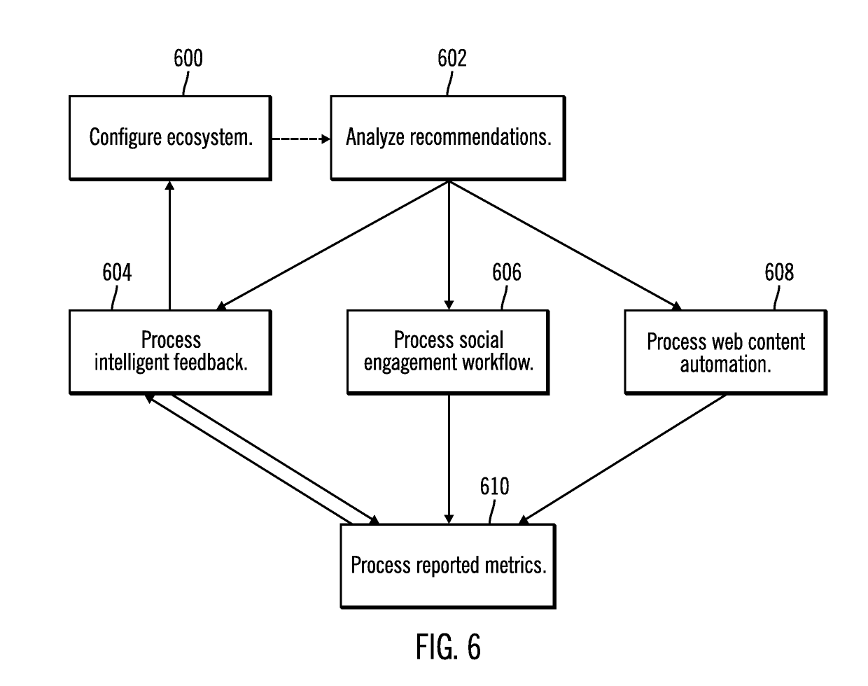

FIG. 6 illustrates, in a flow diagram, certain operations performed by an input agent in accordance with certain embodiments. Control begins at block 600 with the input agent configuring the ecosystem. Between blocks 600 and 602, the processing of blocks 502-508 occurs. In block 602, the input agent analyzes the recommendations provided by the SMCCW system 410. From block 602, processing continues to blocks 604, 606, and 608. In block 604, the input agent processes intelligent feedback. The input agent may use this intelligent feedback to re-configure the ecosystem. In block 606, the input agent processes a social engagement workflow. In block 608, the input agent processes web content automation. From blocks 604, 606, and 608, processing continues to block 610. In block 610, the input agent processes the reported metrics.

The SMCCW system 410 automatically identifies matches between trending topics in social media environments and related content available on a website, and then recommends and automates content and metacontent changes to a website. The SMCCW system 410 gives an administrator control as to which trending topics match their web content and which content should be published, allowing or disallowing social content and or matching web content to be published to the website. The SMCCW system 410 has the level of intelligence and workflow desired by large enterprises for informed content management. The SMCCW system 410 provides customer relationship management workflow capabilities in conjunction with the content management system 420.

As to the data source the SMCCW system 410 is mining, the SMCCW system 410 performs real time, ongoing social intelligence surrounding a brand, industry or any area of interest in external social media venues; identifies which web content on a website maps to these timely social themes; and automates updates of web content which is related to the website in a way that maintains the brand reputation of the business. The SMCCW system 410 utilizes “vocalization” of a broad community. For example, the SMCCW system 410 scans for and identifies what anyone is talking about around a broad topic area (e.g., Information Technology (IT), hardware, etc.).

As to the data source the SMCCW system 410 is acting upon, the SMCCW system 410 uses the content management system 420 to tie the trending topic to the web content 452 and uses one or more workflows to surface content. Surface content may be described as displaying the content on home pages or web pages that have high traffic. Also, the SMCCW system 410 works with various data stores (e.g., a human resource management database to identify subject matter experts for the trending topic for use in engagement) and, thus, provides a workflow for social engagement.

The SMCCW system 410 first identifies which topic should be displayed based on trending discussions. The SMCCW system 410 identifies trending topics around a scoped area (e.g., IT or hardware) and mines social media venues and searches widely to identify trending topics at a broad level (e.g., cloud) at a specific level (e.g., security, cloud). The SMCCW system 410 makes a match to web content 452 available in the content management system 420, which matches that specific topic. The SMCCW system 410 uses rules for weighting (e.g., newness) to provide recommendations to the input agent.

The SMCCW system 410 provides an engagement engine to mention about the new content on social media. For example, the SMCCW system 410 may post a message about the new content using social media. The content curation enabled by the SMCCW system 410 allows content objects to be propagated beyond the website on to other social media presences.

The matches the experts in the organization for the trending topic. The SMCCW system 410 uses this to suggest to the input agent who in the organization can engage with people discussing the trending topics. The input agent then assigns this task to the identified expert using a separate workflow.

The SMCCW system 410 utilizes social media data mining, content mapping, and analytics, but also allows for active participation from input agents (e.g., administrators and a team) to modify the input (what to mine), the output (what gets recommended), and the end result (what is posted). In addition, the SMCCW system 410 allows for workflows to be executed so that tasks can be passed to and from roles (e.g., administrator, marketer, support, expert, sales).

The SMCCW system 410 uses the data retrieved from the scan to decide which topics to recommend at a broad level (e.g., virtualization) and at a specific level (security and virtualization). The SMCCW system 410 uses the data retrieved to automatically update the social media handles and alerts the experts in the business to engage/establish a blog on the trending topic. This type of engagement helps in better customer satisfaction and helps to respond to potential threats, misinformation, and negative feedback. This type of engagement also helps to find what new technology the customer is looking for and helps the business to incorporate those in their products.

The SMCCW system 410 acts as a discovery engine looking for opportunities to enhance present content and new content development, thereby, providing relevant information to visitors both on the website and other social media presences.

The SMCCW system 410 also outputs the engagement engine. The SMCCW system 410 not only updates the website for trending of topic based on social media activity, but also recommends social media experts who can engage with customers based on what the SMCCW system 410 identifies on the social media. The SMCCW system 410, in addition to listening to trending topics, also listens for positive/negative comments about the web content/products offered and provides an opportunity for the business to engage with the customers.

The SMCCW system 410 allows input agents (e.g., administrators) to review and set policy for what content recommendations get added to the website. The SMCCW system 410 also provides a workflow management capability to allow employees to take action on content requiring attention.

The SMCCW system 410 recommends changes to web content automatically based on trending topics obtained from various social media data sources (e.g., blocks, forums, and social networking websites).

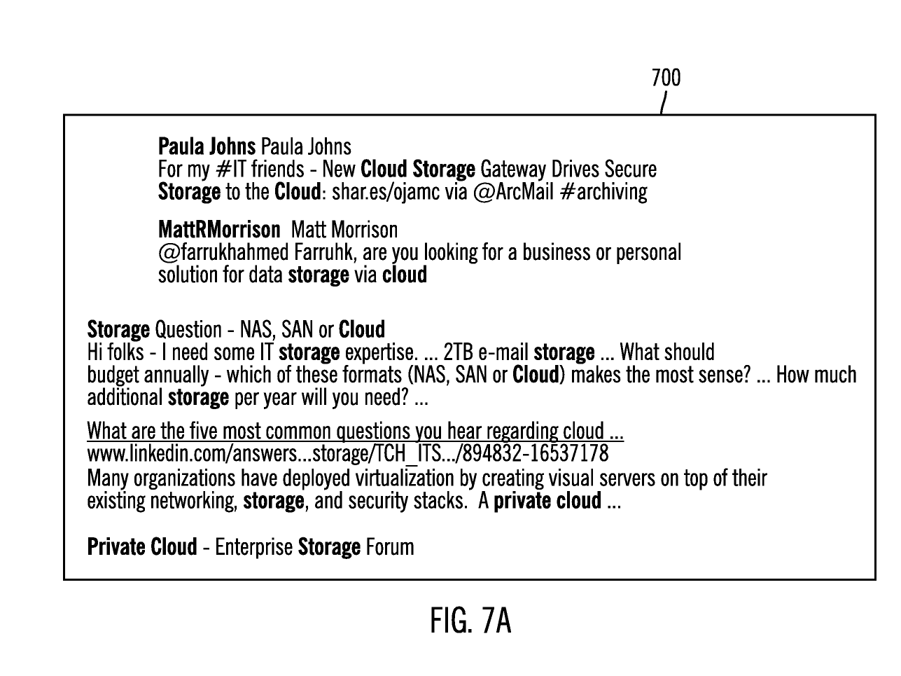

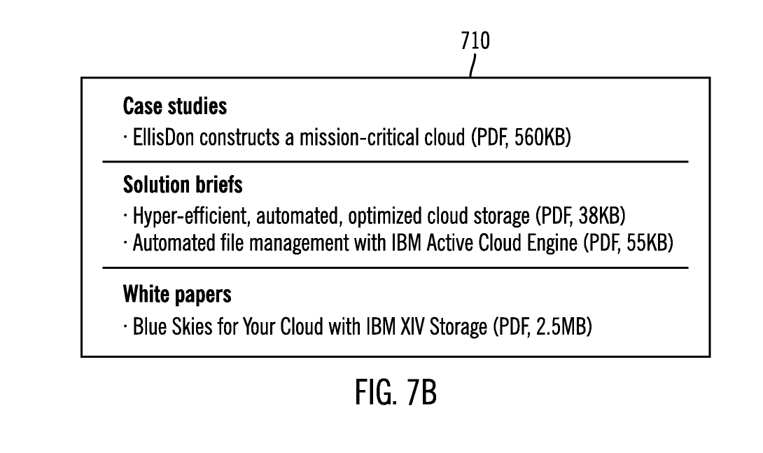

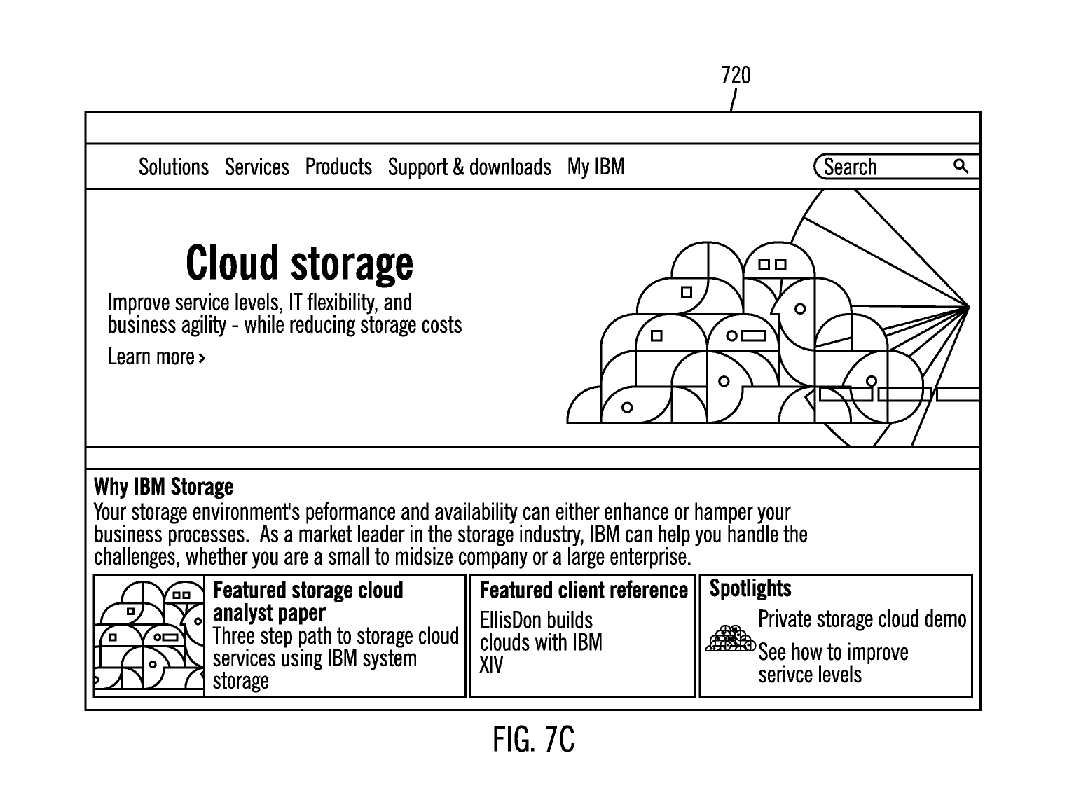

FIGS. 7A, 7B, and 7C illustrate an example of updating a web page with content objects managed by the content management system 420 in accordance with certain embodiments. In block 700 (FIG. 7A), the SMCCW system 410 detects that the term “cloud storage” is a trending topic. In this example, the SMCCW system 410 detects that there are discussions about cloud storage in a forum.

In block 710 (FIG. 7B), the SMCCW system 410 identifies matching content objects in the content management system 420. For example, the SMCCW system 410 identifies a case study (by “Ellis Don”), solution briefs, and a white paper. The SMCCW system 410 sends recommendations to a system administrator about content objects to be added to a target web page.

In block 720 (FIG. 7C), the system administrator approves the recommended content objects and the target web page. In block 720, the web page has been updated to refer to the case study by “Ellis Don”.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, solid state memory, magnetic tape or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package,

partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational processing (e.g., operations or steps) to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The code implementing the described operations may further be implemented in hardware logic or circuitry (e.g., an integrated circuit chip, Programmable Gate Array (PGA), Application Specific Integrated Circuit (ASIC), etc. The hardware logic may be coupled to a processor to perform operations.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of FIGS. 5 and 6 show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the invention, the embodiments reside in the claims hereinafter appended or any subsequently-filed claims, and their equivalents.

1. A computer-implemented method for updating web content, comprising:
associating, with a processor, one or more keywords with one or more topics;
receiving the one or more topics;
performing a data mining scan of one or more data sources for the one or more topics to identify one or more trending topics using the one or more keywords;
identifying one or more content objects related to the one or more trending topics, wherein the one or more content objects are stored in a data store and are managed by a content management system;
providing one or more recommendations on how to update the web content with the one or more content objects;
receiving input accepting the one or more recommendations; and
in response to the received input, automatically updating the web content to include the one or more content objects.

2. The method of claim 1, wherein software is provided as a service in a cloud environment.

3. The method of claim 1, wherein the content objects comprise social media objects, and further comprising:
posting a message about the one or more content objects using social media.

4. (canceled)

5. The method of claim 1, further comprising:
creating a profile for use in recommending a person; and
building a map of an extended social network for the person based on a social media account included in the profile.

6. The method of claim 1, further comprising:
determining whether the scan is good based on relevance of results of the data mining scan;
in response to determining that the scan was irrelevant, reconfiguring a scope of the data mining scan by identifying one or more new data sources; and
performing the data mining scan on the one or more data sources and the one or more new data sources.

7. The method of claim 1, further comprising:
managing a social engagement workflow by recommending experts to notify who can act upon the one or more recommendations.

8. The method of claim 1, further comprising:
leveraging intelligent feedback for keyword optimization by:
making a first list of keywords to be included and a second list of keywords to be excluded; and
based on business rules, automatically updating the one or more keywords for use in performing the data mining scan using the first list of keywords and the second list of keywords.

9. The method of claim 1, further comprising:
reporting metrics that include data mining metrics, workflow metrics, effectiveness metrics, and views.

10. A computer system for updating web content, comprising:
a processor; and
a storage device connected to the processor, wherein the storage device has stored thereon a program, and wherein the processor is configured to execute instructions of the program to perform operations, wherein the operations comprise:
associating, with a processor, one or more keywords with one or more topics;
receiving the one or more topics;
performing a data mining scan of one or more data sources for the one or more topics to identify one or more trending topics using the one or more keywords;
identifying one or more content objects related to the one or more trending topics, wherein the one or more content objects are stored in a data store and are managed by a content management system;
providing one or more recommendations on how to update the web content with the one or more content objects;
receiving input accepting the one or more recommendations; and
in response to the received input, automatically updating the web content to include the one or more content objects.

11. The computer system of claim 10, wherein the operations further comprise:
creating a profile for use in recommending a person; and
building a map of an extended social network for the person based on a social media account included in the profile.

12. The computer system of claim 10, wherein the operations further comprise:
determining whether the scan is good based on relevance of results of the data mining scan; in response to determining that the scan was irrelevant, reconfiguring a scope of the data mining scan by identifying one or more new data sources; and
performing the data mining scan on the one or more data sources and the one or more new data sources.

13. The computer system of claim 10, wherein the operations further comprise:
managing a social engagement workflow by recommending experts to notify who can act upon the one or more recommendations.

14. The computer system of claim 10, wherein the operations further comprise:
leveraging intelligent feedback for keyword optimization by:
making a first list of keywords to be included and a second list of keywords to be excluded; and
based on business rules, automatically updating the one or more keywords for use in performing the data mining scan using the first list of keywords and the second list of keywords.

15. The computer system of claim 10, wherein the operations further comprise:
reporting metrics that include data mining metrics, workflow metrics, effectiveness metrics, and views.

16. A computer program product for updating web content, the computer program product comprising:
a computer readable storage medium having computer readable program code embodied therewith, the computer readable program code, when executed by a processor of a computer, is configured to perform operations comprising:
associating, with a processor, one or more keywords with one or more topics;
receiving the one or more topics;
performing a data mining scan of one or more data sources for one or more topics to identify one or more trending topics using the one or more keywords;
identifying one or more content objects related to the one or more trending topics, wherein the one or more content objects are stored in a data store and are managed by a content management system;
providing one or more recommendations on how to update the web content with the one or more content objects based on the one or more relationships;
receiving input accepting the one or more recommendations; and
in response to the received input, automatically updating the web content to include the one or more content objects.

17. The computer program product of claim 16, wherein the computer readable program code, when executed by the processor of the computer, is configured to perform operations comprising:
creating a profile for use in recommending a person; and
building a map of an extended social network for the person based on a social media account included in the profile.

18. The computer program product of claim 16, wherein the computer readable program code, when executed by the processor of the computer, is configured to perform operations comprising:
determining whether the scan is good based on relevance of results of the data mining scan;
in response to determining that the scan was irrelevant, reconfiguring a scope of the data mining scan by identifying one or more new data sources; and
performing the data mining scan on the one or more data sources and the one or more new data sources.

19. The computer program product of claim 16, wherein the computer readable program code, when executed by the processor of the computer, is configured to perform operations comprising:
managing a social engagement workflow by recommending experts to notify who can act upon the one or more recommendations.

20. The computer program product of claim 16, wherein the computer readable program code, when executed by the processor of the computer, is configured to perform operations comprising:
leveraging intelligent feedback for keyword optimization by:
making a first list of keywords to be included and a second list of keywords to be excluded; and
based on business rules, automatically updating the one or more keywords for use in performing the data mining scan using the first list of keywords and the second list of keywords.

21. The computer program product of claim 16, wherein the computer readable program code, when executed by the processor of the computer, is configured to perform operations comprising:
reporting metrics that include data mining metrics, workflow metrics, effectiveness metrics, and views.

22. The method of claim 1, further comprising:
providing a visual view of the one or more trending topics, wherein the visual view enables drilling down through the trending topics to the one or more topics, the one or more keywords, and the one or more content objects.
